(19) United States
(12) Patent Application Publication
(10) Pub. No.: US 2004/0208598 A1
(43) Pub. Date: Oct. 21, 2004

(54) Optical wireless transceiver

(76) Inventors: John C. Wittenberger, Barrington, RI (US); Marshall C. Hudson, Northborough, MA (US)

Correspondence Address: TEXAS INSTRUMENTS INCORPORATED, P O BOX 655474, M/S 3999, DALLAS, TX, 75265

(21) Appl. No.: 10/208,913

(22) Filed: Jul. 30, 2002

(51) Int. Cl. H04B 10/00

(52) U.S. Cl. 398/130

(57) ABSTRACT

A wireless communication system for minimizing interference from physical limitations and the environment that includes at least a pair of optical links wherein each link includes a steered-beam transmitter assembly (10) and a steered-beam receiver assembly (50). The steered-beam transmitter assembly (10) couples a data signal to be transmitted and a first control signal. The steered-beam transmitter assembly (10) includes a first micromirror assembly (22) for directing the transmitted data signal. The steered-beam receiver assembly (50) couples to receive the data signal having the first control signal coupled thereto to generate a second and a third control signal. The steered-beam receiver assembly (50) includes a second micromirror assembly (62) for directing the received data signal. The second and third control signals position the first and second micromirror assembly (22, 62), respectively, such that the data signal is centered in the field of view of the steered-beam receiver assembly (50). Thus, the generated control signals effectively steer the data signal that is transmitted by the steered-beam transmitter assembly (10) and the data signal received by the steered-beam receiver assembly (50).

### CROSS-REFERENCE TO RELATED APPLICATION

The present invention relates to the copending application entitled “Co-Aligned Receiver and Transmitter For Wireless Link,” Serial No. TBD (TI-32191), filed on Nov. 2, 2001, which is incorporated by reference herein.

### FIELD OF THE INVENTION

The present invention relates to optical communication, and, more particularly, to high speed optical wireless links.

### BACKGROUND OF THE INVENTION

Free-space optics enables fast deployment of broadband access services. A conventional free-space optical link includes two optical transceivers accurately aligned with each other given a clear field of view. Typically, each optical transceiver is mounted on a pole or on the roof or wall of a building. The optical transceiver includes a laser transmitter and receiver to provide full duplex capability. Adversely, atmospheric conditions have a significant impact on the optical link performance, causing severe problems in performance.

Specifically, weather conditions, such as, fog, barometric pressure, and temperature may adversely affect the operation of the laser within the transmitter and between the field of view of the receiver and the transmitter. Thus, the availability of a free-space optical link is conventionally determined by the link length and fog patterns given a specific location.

In addition, a variety of physical limitations impedes the performance of an optical link. One such physical limitation is vibration since it produces both transitional and rotational movement of the receiver and the transmitter. If the vibrational rotation is larger than the transmitter beam divergence, or the receiver field of view, then the data flow between the transmitter and receiver will be lost. Thus, power cannot be sent from the transmitter to the receiver nor can the receiver collect power from the transmitter.

A traditional solution is to make the free space optical link sturdy while being fixed to the building, pole or wall. This solution, however, leads to the pole, wall, or building being the primary source of vibration which cannot be simply controlled.

Another approach increases the divergence beam size of the transmitter so that the divergence is larger than the rotational vibration. Given a fixed power, however, the beam intensity is inversely proportional to the divergence squared and, thereby, inversely proportional to the distance squared. Thus, if the divergence is doubled, the maximum working distance must be reduced to one half or the emitted beam power must be increased by a factor of four.

An alternative approach increases the field of view of the receiver such that the field of view is wider than the rotational vibration. The field of view is the angle across which a beam can be detected by the receiver. This is determined by the receiver's data detector radius and the data optics' focal length. Reducing the focal length of the data optics is not usually done as this also decreases the diameter of the data optics within the receiver and the amount of power that the data detector receives. Instead, the radius of the data detector is increased. Capacitance of the data detector, however, is proportional to its area or proportional to the radius squared. The response time of the data detector is inversely proportional to the capacitance. Thus, by increasing the field of view, the data rate of the receiver is limited.

Furthermore, increasing the field of view of the receiver increases the sensitivity of the receiver to all sources of light within its field of view which includes sunlight, artificial lighting or another transmitter. As a result, the bit error rate may increase.

Thus, a need exists for a device and system that transmits optical data while minimizing interference from physical limitations.

### SUMMARY OF THE INVENTION

To address the above-discussed deficiencies of wireless communication systems, the present invention teaches a system including at least a pair of free-space optical transceiver links wherein each link includes a steered-beam transmitter assembly and a steered-beam receiver assembly. The steered-beam transmitter assembly couples a first control signal to a data signal to be transmitted. The steered-beam transmitter assembly includes a first micromirror assembly for directing the transmitted data and coupled first control signal. The steered-beam receiver assembly aligns to receive the data signal having the first control signal coupled thereto to generate a second and a third control signal. The steered-beam receiver assembly includes a second micromirror assembly for directing the received data signal. The second and third control signals position the first and second micromirror assembly, respectively, such that the data signal is centered in the field of view of the steered-beam receiver assembly. Thus, the generated control signals effectively steer the data signal that is transmitted by the steered-beam transmitter assembly and the data signal received by the steered-beam receiver assembly.

Advantages of this design include but are not limited to a system that transmits optical data while minimizing interference from physical limitations and the environment in that it gives the free-space optical transceiver link the ability to operate in extreme environmental temperatures. This design increases the optical wireless range. Ultimately, the control signals, independent from the data signals, act as pilot signals which position and align the data signals to be transmitted for efficient communication.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a wireless communication system in accordance with the present invention;

FIG. 2 illustrates an exploded view of the steered-beam transmitter assembly in accordance with the present invention;

FIG. 3 displays a cross-sectional view of the assembled steered-beam transmitter assembly in accordance with the present invention;

FIG. 4 illustrates an exploded view of the steered-beam receiver assembly in accordance with the present invention; and

FIG. 5 shows a cross-sectional view of the assembled steered-beam receiver assembly in accordance with the present invention.

### DETAILED DESCRIPTION OF PREFERRED EMBODIMENTS

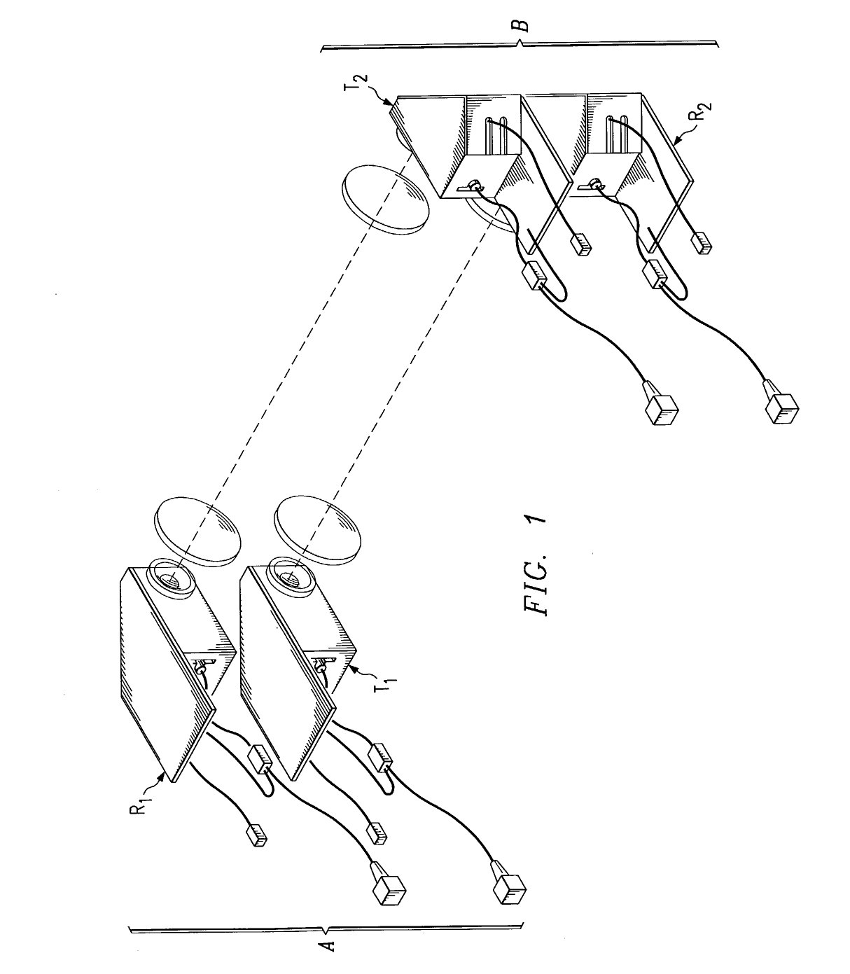

As illustrated in FIG. 1, a wireless communication system includes at least one free-space optical transceiver link including steered-beam transmitter assembly T₁ and steered-beam receiver assembly R₁ at a first location A within a network establishing communications with another free-space optical transceiver link including steered-beam transmitter assembly T₂ and steered-beam receiver assembly R₂ at a second location B within the network. Each free-space optical transceiver link further includes receiver electronics, RE₁ and RE₂ (not shown) and transmitter electronics, TE₁ and TE₂ (not shown).

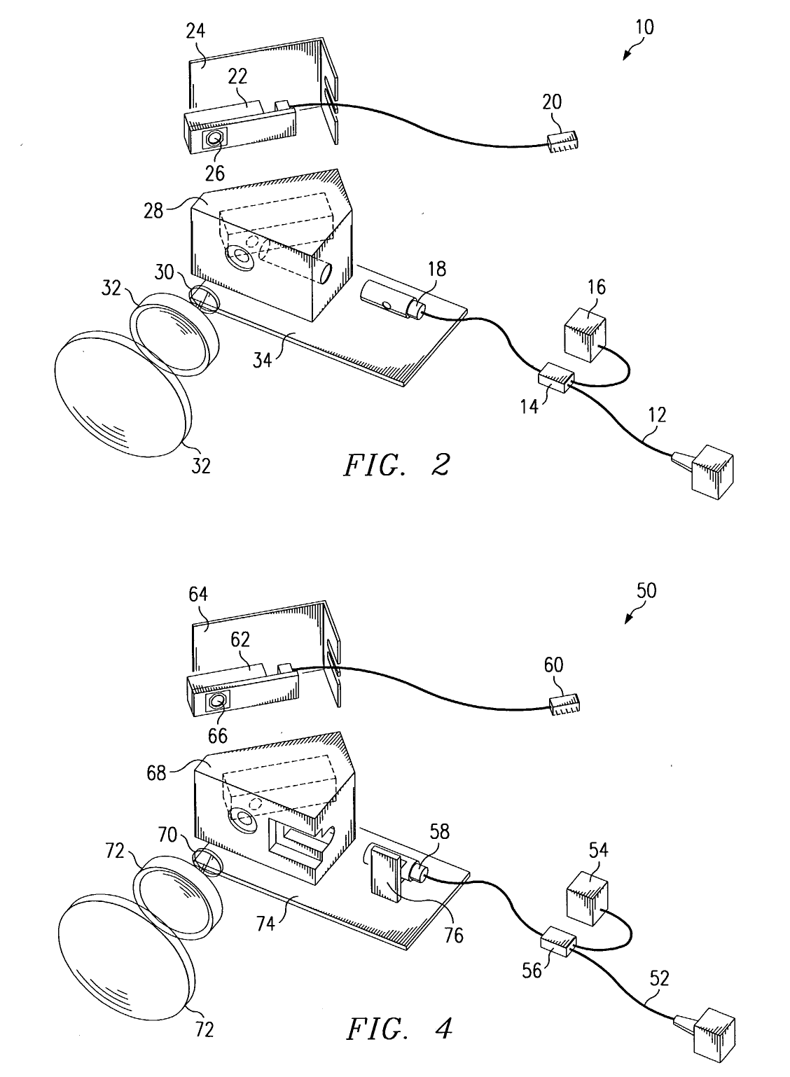

FIG. 2 displays an exploded view of the steered-beam transmitter assembly 10 in accordance with the present invention. A data signal is received by the fiber optics connector cable 12 and is coupled by coupler 14 with a first control signal emitted from control emitter 16. The control signal wavelength may differ from the wavelength of the data signal. Several sources of energy may be used for control emitter 16. These may include a discrete laser such as a vertical cavity surface emitting laser (VCSEL) or a Fabry Perrot laser, a discrete light emitting diode (LED), a single mode fiber optic with or without wave-division multiplexing (WDM), or a multimode fiber optics with or without WDM. Cable 12 connects to user equipment (not shown) where transmission wavelength, the number of transmission wavelengths and optical power level may be selected.

Collimator 18 collimates the data signal having the control signal coupled thereto directing the signal towards a micromirror assembly 22. Micromirror assembly 22 includes a movable mirror or micromirror 26 that redirects and steers the collimated beam towards a beam expander 32. Beam expander 32 may be implemented using a Galilean or Kepler telescope having a lens assembly that expands the beam and allows the user to transmit higher optical power while remaining safe for the eye. The larger beam has reduced divergence. Both the higher power and reduced divergence allow the user to transmit the signal over longer distances. In the same proportion that the beam diameter is expanded, the total beam deflection is reduced for the same micromirror deflection.

In addition, the steered-beam transmitter assembly may include a cover 24 surrounding micromirror assembly 22 wherein micromirror 26 receives control signals through cable 20 from the transmitter electronics TE₁. Further, the steered-beam transmitter assembly 10 may include a control printed circuit assembly (PCA) 34 coupled to micromirror assembly 22. A mount structure 28 may be used for mounting all components. A window 30 embedded within mount 28 may be used to protect micromirror 26 from dust and air movement. Further, micromirror assembly 22 may include internal position feedback.

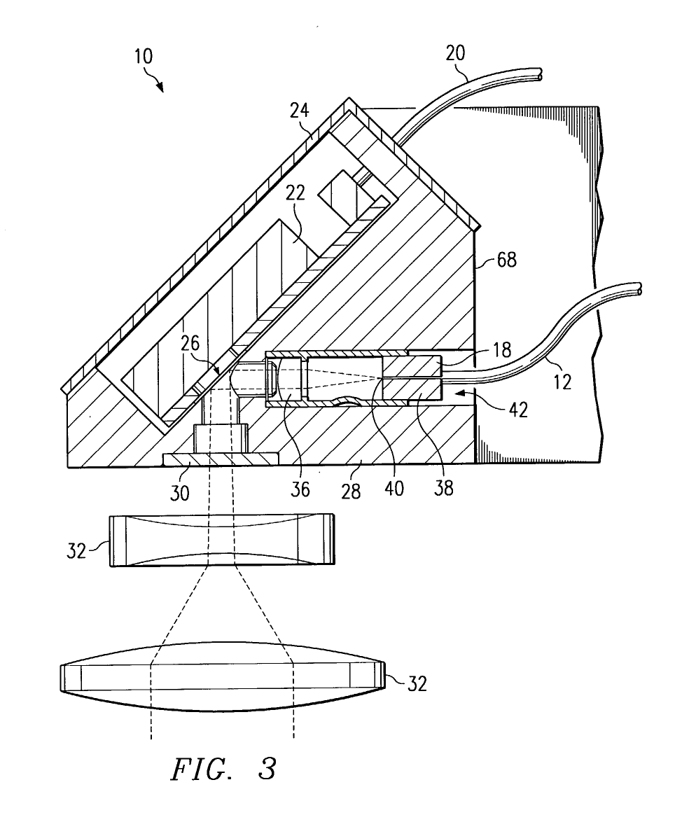

FIG. 3 illustrates the cross-sectional view of the steered-beam transmitter assembly 10. The data and control signals traverse cable 12 to a fiber 40 centered in a ferrule 38. Ferrule 38 fits into a lens barrel 42 which holds the collimating lens 36. The light beam traverses to a collimator lens 36 to collimate the beam. The collimated beam is reflected off micromirror 26 through window 30 towards beam expander 32 to transmit this signal to a steered-beam receiver assembly at a different location such as receiver R₂ at location B illustrated in FIG. 1.

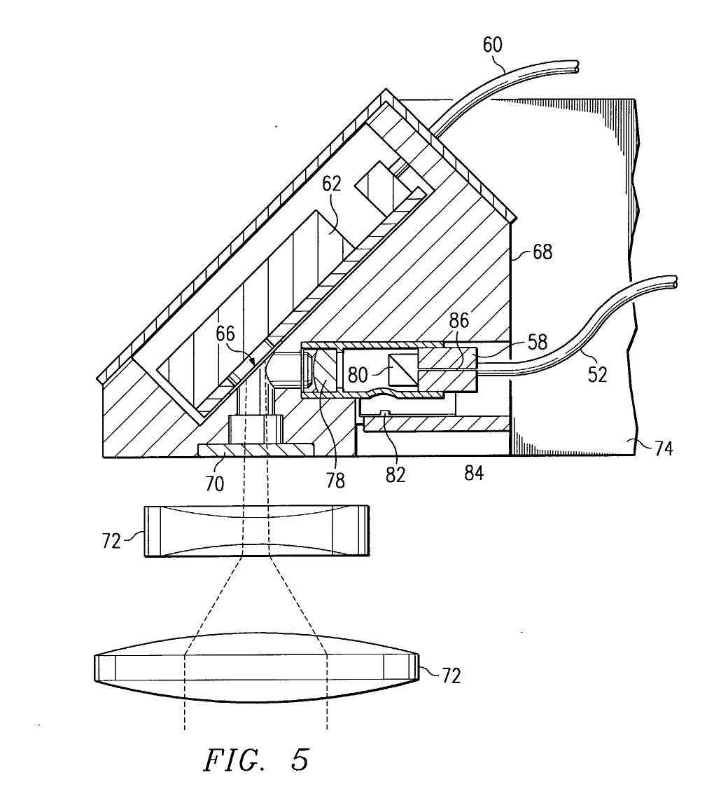

FIG. 4 shows an exploded view of the steered-beam receiver assembly 50 in accordance with the present invention. A data and coupled first control signal is received by beam reducer 72 which may be a Galilean or Kepler telescope having a lens assembly that reduces the beam received. Beam reducer 72 directs the contracted beam through window 70 towards micromirror 66 contained in micromirror assembly 62. Micromirror 66 redirects the beam towards collimator assembly 58. The collimated beam is sent towards beam splitter 56 which splits the beam into two signals: a first beam including the first control beam and a second beam including the data signal. The first beam is redirected towards control detector 54, while the beam including the data signal is sent to the network through cable 52.

In addition, steered-beam receiver assembly 50 may include a micromirror assembly 62 having a cover 64 wherein the micromirror receives control signals through a cable 60. Further, steered-beam receiver assembly 50 may include a control PCA 74 and a servo PCA 76 coupled to micromirror assembly 62 and collimator assembly 58. Mount structure 68 may be used for mounting all components. A window 70 embedded within mount 68 may be used to protect micromirror 66 from dust and air movement. Further, micromirror assembly 62 may include have internal position feedback.

FIG. 5 illustrates the cross-sectional view of steered-beam receiver assembly 50. The data signal is received by beam reducer 72 which is aligned to contract the beam and direct the beam through window 70 towards micromirror 66. Micromirror 66 redirects the beam towards collimator assembly 58 that includes a positive lens 78, a beam splitter 80, a servo detector 82, fiber 84, and ferrule 86. Positive lens 78 focuses the beam and directs it towards beam-splitter 80 which splits the beam into a third and fourth beam wherein the fourth beam includes a portion of the control signal and is redirected towards servo detector 82 for measuring the position of the beam to assure that the beam centers on fiber 84. The center of servo detector 82 is located on the same optical axis as receiver fiber optics 84 and is located at the same distance from positive lens 78 as receiver fiber optics 84. This ensures that focused radiation on servo detector 82 has the same spatial relationship as the focused radiation has on fiber optics 84. In summary, beam splitter 80 sends a portion of the incoming radiation to servo detector 82 using the fourth beam and the remaining radiation to fiber optics 84 using the third beam. Beam splitter 80 can be implemented using a dichroic mirror that reflects the control signal onto servo detector 82 and passes all data signal radiation to fiber 84. Ultimately, servo PCA 76 captures the signal from the four quadrants of servo detector 82 and sums the signals strength, while the third beam continues to traverse through fiber 84 and ferrule 86 towards the network through cable 52 to beam splitter 80 as described above. Beam splitter 56 removes the control signal from the fiber optics cable 52 and sends the control signal to the control detector 54.

Each free-space optical transceiver link includes transmitter electronics (not shown) which couples to control emitter 16, micromirror connector 20 and receiver electronics (not shown) of the adjacent steered-beam receiver assembly. In addition, each optical wireless link includes receiver electronics (not shown) that connects to the control detector 54 and the micromirror connector 60.

In operation, focusing on FIG. 1, to obtain any signal from transmitter assembly T₁, receiver assembly R₂ must have its axis or center of field of view directly aimed at transmitter assembly T₁ Thus, the micromirror of transmitter assembly T₁ is held stationary while the micromirror of receiver assembly R₂ adjusts such that the incoming control signal is centered on the servo detector of receiver assembly R₂. Once the micromirror of receiver assembly R₂ adjusts, the micromirror of receiver assembly R₂ remains stationary and the micromirror of transmitter assembly T₁ adjusts a small distance in one direction. The servo detector of receiver assembly R₂ determines if the signal strength is increased or decreased and passes this information to transmitter assembly T₂ so that transmitter assembly T₂ can transfer this to receiver assembly R₁. When receiver assembly R₁ receives the signal strength information of the control signal of transmitter assembly T₁, receiver assembly R₁ passes this information to transmitter assembly T₁. At this point, transmitter assembly T₁ assesses whether the micromirror of transmitter assembly T₁ was moved the correct direction to maximize the received signal strength of its control beam. Using this process transmitter assembly T₁ optimizes its aim of the control beam by adjusting its micromirror in two angular directions. This process in repeated until the received signal strength is maximized. Thereby, in the presence of vibration, the transmitting beam and the receiving beam move together, keeping in communication one with another.

The system contains four micromirrors and thus has four servo control loops. The first transmitter servo control loop (TSC₁) begins when control emitter 16 emits pulses of light having a second transmitter servo control loop information (TSC₂) and other encoded information. Coupler 14 combines this control signal with an incoming data signal from cable 12. Transmitter T₁ transmits the signal from a first location A to a receiver R₂ at a second location B. Receiver R₂ collects the incoming data and control beam and images the data beam and a portion of the control beam into the fiber 84 that goes between the collimator assembly 58 and the beam splitter 56. The beam splitter 56 removes the control beam and sends the control beam to control detector 54. Control detector 54 detects the average power in the control beam and sends this information regarding the first transmitter servo control loop (TSC₁) to the receiver electronics (not shown) of receiver R₂ which sends the first transmitter servo control loop (TSC₁) information to the transmitter electronics of transmitter T₂. The transmitter electronics of transmitter T₂ encodes the first transmitter servo control loop (TSC₁) information in the pulses generated by control emitter 16. This control beam which includes TSC₁ encoded pulses is combined with an incoming data signal at the second location B. This signal is transmitted to the first location A.

At the first location A, receiver R₁ collects the incoming data signal and images the data beam and a portion of the control beam into the fiber 84 that goes between the collimator assembly 58 and the beam splitter 56. The beam splitter 56 removes the control beam and sends it to control detector 54. Control detector 54 detects the pulses that represents TSC₁ information and sends this information to the receiver electronics of the receiver R₁. Receiver electronics of the receiver R₁ sends TSC₁ information to transmitter electronics of transmitter T₁. Using the TSC₁ information, transmitter electronics of transmitter T₁ determines the correct adjustment of the micromirror of transmitter T₁ and sends a correcting control current to the micromirror of transmitter T₁. Ultimately, the micromirror of transmitter T₁ moves in a direction to maximize the average power received at the control detector 54 of receiver R₂.

The second receiver servo control loop (RSC₂) includes the following process. Beam splitter 80 of receiver R₂ redirects a portion of the control beam from transmitter T₁ to be imaged onto the servo detector 82. Servo detector 82 passes the position information to of the receiver electronics of receiver R₂ which determines the correct adjustment for the micromirror 66 of receiver R₂ and sends a correcting control current signal to the micromirror 66 of receiver R₂.

The second transmitter servo control loop (TSC₂) includes the following process. Control emitter 16 of transmitter T₂ emits pulses of light including TSC₁ information. This control signal is combined with the incoming data signal and transmitted from the second location B to the first location A. At location A, receiver R₁ collects the incoming data and images the data beam and a portion of the control beam into the fiber 84 that goes between the collimator assembly 58 and beam splitter 56. Beam splitter 56 removes the control beam and sends the control beam to control detector 54 of receiver R₁ which detects the average power in the control beam and sends the TSC₂ information the receiver electronics for receiver R₁.

The receiver electronics for receiver R₁ sends the TSC₂ information to the transmitter electronics for transmitter T₁. Control emitter 16 of transmitter T₁ encodes the TSC₂ information into the pulses of a control beam. This control beam is combined with the incoming data at the first location A and transmitted to location B. At location B, receiver R₂ collects the incoming data signal and images the data beam and a portion of the control beam into fiber 84 that goes between the collimator assembly 58 and the beam splitter 56. Beam splitter 56 removes the control beam and sends the control beam to control detector 54 of receiver R₁ which detects the TSC₂ information and sends the TSC₂ information the receiver electronics for receiver R₂. The receiver electronics for receiver R₂ sends the TSC₂ information to the transmitter electronics for transmitter T₂. Using the TSC₂ information, the transmitter electronics for transmitter T₂ determines the correct adjustment of micromirror 26 for transmitter T₂ and sends a correcting control current signal to micromirror 26. Accordingly, micromirror 26 moves in a direction to maximize the average power at the control detector 54 of receiver R₁.

The first receiver servo control loop (RSC₁) includes the following process. Beam splitter 80 of receiver R₁ redirects a portion of the control beam from transmitter T₂ to be imaged onto the servo detector 82. Servo detector 82 passes the position information to of the receiver electronics of receiver R₁ which determines the correct adjustment for the micromirror 66 of receiver R₁ and sends a correcting control current signal to the micromirror 66 of receiver R₁.

Advantages of this design include but are not limited to a system that transmits optical data while minimizing interference from physical limitations.

The reader's attention is directed to all papers and documents which are filed concurrently with this specification and which are open to public inspection with this specification, and the contents of all such papers and documents are incorporated herein by reference.

All the features disclosed in this specification (including any accompany claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An optical link for communicating data within a wireless communication network, comprising:
a steered-beam transmitter assembly, having a first micromirror assembly, the steered-beam transmitter assembly coupled to receive a data signal to be transmitted for coupling a first control signal to the data signal, the first micromirror assembly for directing the transmitted data signal;
a steered-beam receiver assembly, having a second micromirror assembly for directing a received signal and having a field of view, the steered-beam receiver assembly coupled to receive the data signal having the first control signal coupled thereto to generate a second and a third control signal to position the first and second micromirror assembly, respectively, such that the data signal is centered in the field of view of the steered-beam receiver assembly.

2. The optical link as recited in claim 1, wherein the steered-beam transmitter assembly comprises:
an electromagnetic radiation source to generate a first beam of radiation;
a modulator coupled to receive the data signal and the first beam of radiation to modulate the beam with the data signal;
a beam coupler coupled to receive the modulated first beam of radiation and the first control signal to couple the first beam and the first control signal together;
a collimator lens coupled to receive the first beam having the first control signal coupled thereto to collimate the first beam;
the first micromirror assembly coupled to receive the collimated first beam and enabled to direct the collimated beam, responsive to the second control signal; and
a beam expander coupled to receive the beam to expand the diameter of the beam.

3. The optical link as recited in claim 2, wherein the first micromirror assembly is enabled to deflect the collimated first beam in either an X and a Y axis.

4. The optical link as recited in claim 2, wherein the beam expander is a Galilean telescope.

5. The optical link as recited in claim 2, wherein the beam expander is a Kepler telescope.

6. The optical link as recited in claim 1, wherein the steered-beam receiver assembly comprises:
a beam reducer coupled to receive the expanded beam of the steered-beam transmitter assembly to contract the diameter of the beam;
a second micromirror assembly coupled to receive the contracted beam and enabled to direct the contracted beam;
a positive lens coupled to receive the beam to focus the beam;
a first beam splitter coupled to receive the beam to separate the beam into a second beam including the data signal and the control signal and a third beam including a portion of the control signal;
a servo detector coupled to receive the third beam to generate the third control signal responsive to the position control information corresponding to the center of view of the steered-beam receiver assembly for repositioning of the second micromirror assembly;
a second beam splitter coupled to receive the second beam to separate the beam into a fourth beam including the data signal and a fifth beam including the control signal; and
a control detector coupled to receive the fifth beam to detect the average power of the first beam and to generate the second control signal for repositioning of the first micromirror assembly.

7. The optical link as recited in claim 5, wherein the second micromirror assembly is enabled to deflect the contracted beam in either an X and a Y axis.

8. The optical link as recited in claim 5, wherein the beam contractor is a Galilean telescope.

9. The optical link as recited in claim 5, wherein the beam contractor is a Kepler telescope.

10. The system as recited in claim 1, wherein the wavelength of the data signal is different from the wavelength of the control signal.

11. A system of optical equipment that transmits data between a first and a second network, comprising:
at least a pair of optical links coupled one to another, wherein each optical link comprises,
a steered-beam transmitter assembly, having a first micromirror assembly, the steered-beam transmitter assembly coupled to receive a data signal to be transmitted for coupling a first control signal to the data signal, the first micromirror assembly for directing the transmitted data signal;
a steered-beam receiver assembly, having a second micromirror assembly for directing a received signal and having a field of view, the steered-beam receiver assembly coupled to receive the data signal having the first control signal coupled thereto to generate a second and a third control signal to position the first and second micromirror assembly, respectively, such that the data signal is centered in the field of view of the steered-beam receiver assembly.

12. The system as recited in claim 11, wherein the steered-beam transmitter assembly comprises:
an electromagnetic radiation source to generate a first beam of radiation;
a modulator coupled to receive the data signal and the first beam of radiation to modulate the beam with the data signal;
a beam coupler coupled to receive the modulated first beam of radiation and the first control signal to couple the first beam and the first control signal together;
a collimator lens coupled to receive the first beam having the first control signal coupled thereto to collimate the first beam;
the first micromirror assembly coupled to receive the collimated first beam and enabled to direct the collimated beam, responsive to the second control signal; and
a beam expander coupled to receive the beam to expand the diameter of the beam.

13. The optical link as recited in claim 12, wherein the first micromirror assembly is enabled to deflect the collimated first beam in either an X and a Y axis.

14. The optical link as recited in claim 12, wherein the beam expander is a Galilean telescope.

15. The optical link as recited in claim 12, wherein the beam expander is a Kepler telescope.

16. The system as recited in claim 11, wherein the steered-beam receiver assembly comprises:
a beam reducer coupled to receive the expanded beam of the steered-beam transmitter assembly to contract the diameter of the beam;
a second micromirror assembly coupled to receive the contracted beam and enabled to direct the contracted beam;
a positive lens coupled to receive the beam to focus the beam;
a first beam splitter coupled to receive the beam to separate the beam into a second beam including the data signal and the control signal and a third beam including a portion of the control signal;
a servo detector coupled to receive the third beam to generate the third control signal responsive to the intensity control information corresponding to the center of view of the steered-beam receiver assembly for repositioning of the second micromirror assembly;
a second beam splitter coupled to receive the second beam to separate the beam into a fourth beam including the data signal and a fifth beam including the control signal; and
a control detector coupled to receive the fifth beam to detect the average power of the first beam and to generate the second control signal for repositioning of the first micromirror assembly.

17. The system as recited in claim 16, wherein the second micromirror assembly is enabled to deflect the contracted beam in either an X and a Y axis.

18. The optical link as recited in claim 16, wherein the beam expander is a Galilean telescope.

19. The optical link as recited in claim 16, wherein the beam expander is a Kepler telescope.

20. The system as recited in claim 11, wherein the wavelength of the data signal is different from the wavelength of the control signal.

21. A method of transmitting data in an optical wireless network, comprising:
coupling a first control signal to a data signal from a first location within the network modulated with radiation from an energy source within a steered beam transmitter assembly having a first micromirror assembly;
transmitting the data signal from the steered beam transmitter assembly;
receiving the data signal from the steered beam transmitter assembly;
splitting the data signal having the first control signal coupled thereto into a first beam and a second beam;
reflecting the second beam onto a servo detector;
generating a second control signal using the information gathered from the servo detector to reposition the first micromirror assembly;
splitting the first beam into a third and fourth beam, wherein the third beam includes the data signal and the fourth beam includes the control signal;
reflecting the fourth beam to a control detector to detect the average power of the data signal;
generating a third control signal using the information gathered from the control detector to reposition the second micromirror assembly; and
receiving the third beam for further processing at a second location within the network.
